(19) United States
(12) Patent Application Publication
(10) Pub. No.: US 2011/0181510 A1
(43) Pub. Date: Jul. 28, 2011

(54) Gesture Control

(75) Inventors: Ilkka-Hermanni HAKALA, Helsinki (FI); Timo Petteri KARTTAAVI, Espoo (FI); Risto Heikki Sakari KAUNISTO, Espoo (FI); Aarno Tapio PARSSINEN, Espoo (FI); Jani Petri Juhani OLLIKAINEN, Helsinki (FI); Ping HUI, Richmond (CA); Kimmo Heikki Juhana KALLIOLA, Helsinki (FI)

(73) Assignee: Nokia Corporation

(21) Appl. No.: 12/711,375

(22) Filed: Feb. 24, 2010

Related U.S. Application Data
(63) Continuation-in-part of application No. 12/693,667, filed on Jan. 26, 2010.

(51) Int. Cl. G06F 3/033; G08C 19/16; G06F 3/046

(52) U.S. Cl. 345/158; 340/5.51; 340/12.5; 715/863

(57) ABSTRACT

An apparatus including one or more radio transmitters configured to transmit radio signals that are at least partially reflected by an object or objects moving as a consequence of a gesture; multiple radio receivers configured to receive the transmitted radio signals after having been at least partially reflected by an object or objects moving as a consequence of a gesture; a detector configured to detect an attribute of the received signals, for each receiver, that varies with the position of the object or objects moving as a consequence of the gesture; and a controller configured to interpret the detected attributes, for the receivers, as a user input associated with the gesture.

### FIELD OF THE INVENTION

Embodiments of the present invention relate to controlling an apparatus using gestures.

### BACKGROUND TO THE INVENTION

It would be desirable to control an apparatus without having to touch it and without having to use a remote control device.

### BRIEF DESCRIPTION OF VARIOUS EMBODIMENTS OF THE INVENTION

According to various, but not necessarily all, embodiments of the invention there is provided an apparatus comprising: one or more radio transmitters configured to transmit radio signals that are at least partially reflected by an object or objects moving as a consequence of a gesture; multiple radio receivers configured to receive the transmitted radio signals after having been at least partially reflected by an object or objects moving as a consequence of a gesture; a detector configured to detect an attribute of the received signals, for each receiver, that varies with the position of the object or objects moving as a consequence of the gesture; and a controller configured to interpret the detected attributes, for the receivers, as a user input associated with the gesture.

In some embodiments, the apparatus is a hand-portable apparatus and in other embodiments the apparatus is a larger fixed-position apparatus.

The use of multiple radio receivers provides reception diversity. Reception diversity may, for example, arise via spatial diversity where the radio receivers are positioned at spatially diverse locations or arise via frequency diversity where the radio receivers are configured to receive at diverse reception frequencies or via polarization diversity where the radio receivers are configured to receive at diverse electromagnetic polarizations.

Multiple radio receivers may be provided by a single radio frequency processing circuit that is connected to multiple different antennas. Alternatively, multiple radio receivers may be provided simultaneously by a multiple radio frequency processing circuits that are each connected to one or more antennas. Alternatively, multiple radio receivers may be provided using time division over an antenna steering period by steering (e.g. sweeping) a directed antenna connected to a radio frequency processing circuit. The term ‘multiple radio receivers’ should therefore be interpreted to encompass these alternatives.

According to various, but not necessarily all, embodiments of the invention there is provided a gesture recognition engine for a gesture controlled user interface comprising: a detector configured to detect an attribute of received signals for each of a plurality of receivers that varies with the position of the object or objects and configured to detect at least one additional parameter for each of the plurality of receivers; and an interface for providing the detected attributes and parameters as an output.

According to various, but not necessarily all, embodiments of the invention there is provided a method comprising: transmitting radio signals that are at least partially reflected by an object or objects moving as a consequence of a gesture; receiving the transmitted radio signals at multiple receivers after having been at least partially reflected by the object or objects moving as a consequence of a gesture; detecting an attribute of the received signals for each of the multiple receivers that varies with the position of the object or objects that characterize the gesture; and changing the operation of an apparatus in dependence upon the detected attributes characterizing the gesture.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus that uses radar with diversity reception to detect gestures;

FIG. 2 illustrates a suitable platform for providing a detector and a controller using software;

FIG. 3 schematically illustrates a gesture recognition engine;

FIG. 4 schematically illustrates an exterior of an apparatus;

FIG. 5 schematically illustrates an alternative embodiment of the apparatus having transmitter diversity; and

FIG. 6 schematically illustrates a method.

### DETAILED DESCRIPTION OF VARIOUS EMBODIMENTS OF THE INVENTION

The Figures schematically illustrate an apparatus 2 comprising: one or more radio transmitters 4 configured to transmit radio signals 6 that are at least partially reflected by an object or objects 8 moving as a consequence of a gesture 9; multiple radio receivers 10 configured to receive the transmitted radio signals 6′ after having been at least partially reflected by an object or objects 8 moving as a consequence of a gesture 9; a detector 12 configured to detect an attribute of the received signals 6′, for each receiver 10, that varies with the position of the object or objects 8 moving as a consequence of the gesture 9; and a controller 14 configured to interpret the detected attributes, for the receivers 10, as a user input associated with the gesture 9. The apparatus 2 is configured to use radar technology to detect a gesture 9, such as a hand gesture, and to interpret the detected gesture as a user input command. The user is therefore able to control the operation of the apparatus 2 without touching the apparatus 2.

Typically the radio waves would be microwaves or millimeter waves which are capable of penetrating clothing etc. A user is therefore able to control the operation of the apparatus 2 using a gesture even when the apparatus is stowed out of sight in a pocket or handbag, for example.

The gesture is typically a non-touching gesture that is a gesture that does not touch the apparatus 2 itself but which involves the movement of all or part of a body. A gesture may be a hand gesture which involves the movement of all or part of the hand.

The detected attribute is a time-based attribute such as time of flight, time difference of arrival or phase that is dependent upon the length of the paths of the radio signals between transmission and their diverse reception. Such an attribute is detected for each receiver. The position or bearing of the object 8 can then be resolved using the attributes and the variation in the position or bearing of the object 8 over time can be detected.

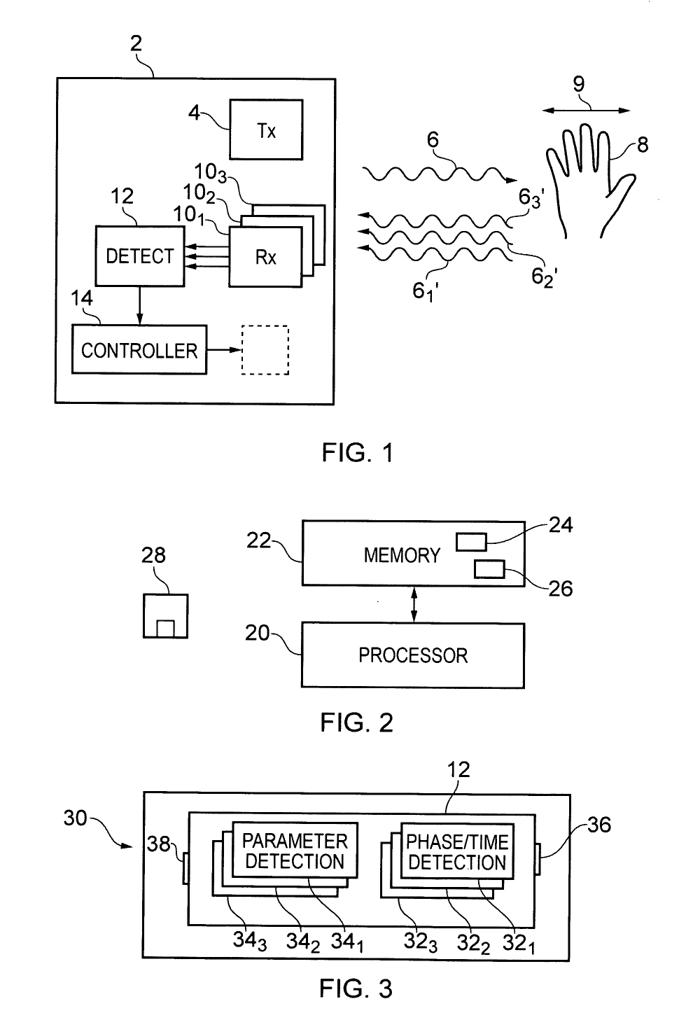

Referring to FIG. 1, there is schematically illustrated an apparatus 2 comprising: a radio transmitter 4; a plurality of radio receivers 10₁, 10₂, 10 a detector 12; and a controller 14.

The apparatus 2 may be any apparatus that it is desirable to control by user input and in particular non-touching gestures. In some but not necessarily all embodiments, the apparatus 2 may be a hand portable apparatus 2 that is sized to fit in the palm of the hand or a jacket pocket. It may, for example, be a personal electronic device such as a music player, a video player, a mobile cellular telephone, an eBook reader etc. In some but not necessarily all embodiments, the apparatus 2 may be a fixed or non-portable apparatus 2 that is not intended to be carried by a user of the apparatus 2, for example, a television set for a living room or an electronic board for meeting rooms or for teaching purposes.

The radio transmitter 4 is configured to transmit radio signals 6 that are at least partially reflected by an object 8. The object 8 may be a part of the human body such as a hand or it may be an item or device that is attached to or held by the human body, for example, a wristwatch or a piece of jewellery. A suitable device would be a conductive object that has a large radar signature. The radio signals may, for example, be microwave signals. The apparatus may, in some embodiments, be configured to additionally use the radio transmitter 4 for wireless data transmission in addition to the described radar gesture detection.

A first radio receiver 10₁ is configured to receive first radio signals 6₁′ that have been transmitted by the radio transmitter 4 and at least partially reflected by, for example, a hand 8 of a user when it is making a non-touching gesture. The first radio receiver 10₁ in this example is fixed relative to the apparatus 2 and does not move or scan in use.

A second radio receiver 10₂ is configured to receive second radio signals 6₂′ that have been transmitted by the radio transmitter 4 and at least partially reflected by, for example, a hand 8 of a user when it is making a non-touching gesture. The second radio receiver 10₂ in this example is fixed relative to the apparatus 2 and does not move or scan in use.

A third radio receiver 10₃ is configured to receive third radio signals 6₃′ that have been transmitted by the radio transmitter 4 and at least partially reflected by, for example, a hand 8 of a user when it is making a non-touching gesture. The third radio receiver 10₃ in this example is fixed relative to the apparatus 2 and does not move or scan in use.

The length of the path of the radio signals 6 from the radio transmitter 4 until detection by the respective radio receivers 10 depends upon the position of the radio receivers 10 (which have a fixed position relative to the apparatus 2) and the position of the object 8 when it reflects the radio signals 6. The relative differences in the paths of signals to the respective first, second, third radio receivers 10 may be detected at detector 12 as an attribute of the received signals 6′, for each receiver 10. The attribute may, for example, in one embodiment be a time of flight measurement. The attribute may, for example, in another embodiment be a time difference of arrival measurement. The attribute may, for example, in another embodiment be a phase measurement.

The detector 12 may, for example, also determine from the received radio signals one or more time variable parameters, for each receiver 10, that parameterize the gesture 9. The parameters may, for example, include Doppler shift (or speed and direction) and/or power for each receiver 10 and/or range.

The controller 14 is configured to interpret the detected attributes, for the multiple receivers, as a predetermined user input command and change the operation of the apparatus 2. The operation of the apparatus 2 is therefore changed without the user touching the apparatus as a result of the gesture.

In some embodiments, the controller 14 may use a knowledge of the relative positions of the radio receivers 10 and the determined attributes to resolve the position of the object 8 in two or three dimensions. The change in the position of the hand can identify a gesture. The controller 14 may be configured to additionally use the detected parameter(s), for the multiple receivers 10, in the interpretation of the predetermined user input command.

In one embodiment, the detected attribute is absolute time of flight. The controller 14 may then use a knowledge of the relative positions of the multiple radio receivers 10 and the determined times of flight to resolve the position of the object in two or three dimensions using trilateration. The change in the position of the object can identify a gesture.

In another embodiment, the detected attribute is time difference of arrival. The controller 14 may then use a knowledge of the relative positions of the multiple radio receivers 10 and the determined time difference of arrival for the receivers 10 to resolve the position of the object in two or three dimensions using multilateration (hyperbolic positioning). The change in the position of the object can identify a gesture.

In another embodiment, the detected attribute is phase. The phase values of the received radio signals 6′ at the multiple receivers 10 can be used by the controller 14 to determine the direction of arrival (bearing) of the radio signals 6′ reflected from the moving object 8.

The direction of arrival of the received radio signals 6′ is resolved based on the phase and possibly amplitude differences of the received signals 6′ at the respective radio receivers 10. In one implementation (the Bartlett Beamformer), the normalized received power in each direction θ is calculated by determining the θ that maximizes a^{H}(θ) R a(θ), where a(θ) is the steering vector of the array of multiple receivers 10 and R is the spatial covariance matrix of the received signals 6′. The steering vector a(θ) may be determined by simulation or calibration.

The change in the direction of arrival of the radio signals 6′ reflected from the moving object 8 can identify a gesture. The controller 14 may additionally use the detected parameter(s), for the multiple receivers 10, in the interpretation of the direction of arrival.

In a further embodiment, the detected attribute is phase. The phase values of the radio signals 6′ received at different sub-sets of the multiple receivers 10 can be used by the controller 14 to determine the direction of arrival of the radio signals 6′ reflected from the moving object 8 for each sub-set.

The direction of arrival of the received radio signals 6′ is resolved based on the phase and possibly amplitude differences of the received signals 6′ at the respective radio receivers 10 of a sub-set. In one implementation (the Bartlett Beamformer), the normalized received power in each direction 6 is calculated by determining the θ that maximizes a^{H}(θ) R a(θ), where a(θ) is the steering vector of the array of receivers 10 in the sub-set and R is the spatial covariance matrix of the received signals 6′ for the sub-set. The steering vector a(θ) may be determined by simulation or calibration.

The different directions of arrival (bearings) for the different sub-sets may be used to estimate the position of the moving object using triangulation. The controller may additionally use the detected parameter(s), for the multiple receivers 10, in the interpretation of the object's position.

The algorithms for positioning using attributes may be used to position the object 8 at each moment in time. In this way, quite complex gestures that involve movement in three dimensions may be detected and used as user input commands.

The controller 14 may associate in a look-up table sets of detected attributes (and possible sets of parameters) with predetermined user input commands to avoid complex real-time calculations. For example, particular combinations of attributes (and possibly parameters) may address a particular command and/or particular combinations of changes in attributes (and possibly parameters) may address a particular command. When the controller 14 receives predetermined time varying attributes (and possibly parameters) resulting from a predetermined gesture it uses the look-up table to determine immediately and automatically the appropriate user input command in response to the gesture.

The associations between the attributes (and, optionally, parameters) and the predetermined user input commands could be stored while manufacturing the apparatus 2 or transferred to the apparatus 2 using a storage media. In some embodiments, it may also be possible to allow user programming of gestures and the response to those gestures. For example, the apparatus 2 may have a learning mode in which a user teaches various gestures to the apparatus 2 and then programs the apparatus 2 to create associations between the time-varying attributes (and parameters) for those gestures and user-defined user input commands.

A lexicon can be formed where the individual discrete gestures are ‘words’ and a grammar may be specified that defines the meaningful combinations of words (sentences). Each word and each sentence can produce a different user input command, if required.

One user input command may change an application mode or function of the apparatus 2. Thus a particular gesture may reject an incoming telephone call and another gesture may answer the call. The user may be able to control the apparatus 2 directly without the need for a graphical user interface or a display at the apparatus 2.

Another user input command may control a user interface of the apparatus 2 and in particular user output devices such as a loudspeaker or a display, for example. The user interface may, for example, be controlled to change how content is presented to a user.

For example, a gesture may increase audio output volume and another gesture may decrease audio output volume. As the user input commands are the opposite of each other, it may be preferable if the gestures that effect those commands were also in an opposite sense to each other.

For example, a gesture may zoom-in on information displayed on a display and another gesture may zoom-out. As the user input commands are the opposite of each other, it may be preferable if the gestures that effect those commands were also in an opposite sense to each other.

For example, a gesture may scroll information in a display up (or left) and another gesture may scroll information in a display down (or right). As the user input commands are the opposite of each other, it may be preferable if the gestures that effect those commands were also in an opposite sense to each other.

In the preceding paragraphs, reference has been made to ‘parameters’ which might include range and/or power and/or Doppler frequency shift (speed, direction), for example. The following paragraphs detail some of these parameters.

In one example, the detector 12 may additionally comprise circuitry configured to measure the interval between the transmission of a signal 6 and its reception as radio signal 6′. The detector 12 determines from the interval of the transmitted radio signal a distance that parameterizes the gesture. This may conveniently be used as a ‘gate’ i.e. to accept as valid only gestures that are within a certain range from the apparatus 2.

In a another example, the detector 12 may comprise a Doppler radar detector configured to determine a frequency difference between the carrier frequency of received radio signals 6′ and the carrier frequency of transmitted radio signals 6. The Doppler radar does not have to be on continuously and may be pulsed to save power. The detector 12 determines from the frequency of the transmitted radio signal the speed and direction that parameterize the gesture or the frequency shift that parameterizes the gesture.

If the object 8 is moving towards the radio receivers 10 the Doppler effect will result in an upwards frequency shift for the radio signals 6′ (compared to the radio signals 6) that is proportional to the velocity of the hand towards the respective radio receiver 10 and if the hand 8 is moving away from a respective radio receiver 10 the Doppler effect will result in a downwards frequency shift for the radio signals 6′ that is proportional to the velocity of the hand away from that radio receiver 10.

In another example, which may be used in combination with the Doppler shift example, if the transmission signals are modulated at transmission so that they have a periodic time signature, the Doppler effect also causes a frequency shift in the periodic time signature. The time signature may, for example, be a periodic variation in amplitude (pulsed Doppler or pulsed Ultra wideband) or a periodic variation in frequency (Frequency Modulated Continuous wave). If the object 8 is moving towards the radio receivers 10 the period between signatures decreases and if the hand 8 is moving away from the receivers the period between signatures increases.

The detector 12 comprises circuitry configured to measure the period between signatures for each receiver 10. The detector 12 may determine from the period of the transmitted radio signal a speed and direction that parameterize the gesture.

In another example, which may be used in combination with the Doppler shift example, if the transmission signals 6 are transmitted with a known power, the power of the received reflected signals 6′ may give an indication of the range or distance of the gesture, or the size of the reflecting object 8. The detector 12 comprises circuitry configured to measure the power difference between transmission and reception for one or more of the receivers 10. The controller 14 may determine whether a gesture is valid based on the received power. For example, the controller 14 may convert the power difference to a distance, or to the size of the reflecting object generating the gesture. It may be used as a ‘gate’ to determine when attributes are valid. For example, there may be a valid range of distances (i.e. greater than a minimum distance but less than a maximum distance) for valid gestures or for the initiation and/or termination of a valid gesture.

FIG. 2 illustrates a suitable platform for providing the detector 12 and the controller 14 using software.

The detector 12 and/or the controller 14 may be implemented using instructions that enable hardware functionality, for example, by using executable computer program instructions in a general-purpose or special-purpose processor that may be stored on a computer readable storage medium (disk, memory etc) to be executed by such a processor.

A processor 20 is configured to read from and write to the memory 22. The processor 20 may also comprise an output interface via which data and/or commands are output by the processor 20 and an input interface via which data and/or commands are input to the processor 20.

The memory 22 stores a computer program 24 comprising computer program instructions that control the operation of the detector 12 and possibly the apparatus 2 when loaded into the processor 20 and/or stores a computer program 26 comprising computer program instructions that control the operation of the controller 14 and possibly the apparatus 2 when loaded into the processor 20.

The computer program instructions provide the logic and routines that enables the apparatus to perform the methods illustrated in FIG. 6. The processor 20 by reading the memory 22 is able to load and execute the computer program 24, 26.

The computer program(s) may arrive at the apparatus 2 via any suitable delivery mechanism 28. The delivery mechanism 28 may be for example, a computer-readable storage medium, a computer program product, a memory device, a record medium such as a CD-ROM or DVD, an article of manufacture that tangibly embodies the computer program. The delivery mechanism may be a signal configured to reliably transfer the computer program over the air or via an electrical connection. The apparatus 2 may propagate or transmit the computer program as a computer data signal.

Although the memory 22 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single /multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Thus the apparatus 2 may comprise at least one processor 20 and at least one memory 22 including computer program code 24, the at least one memory 22 and the computer program code 24 configured to, with the at least one processor, provide the detector 12.

Thus the apparatus 2 may comprise at least one processor 20 and at least one memory 22 including computer program code 26, the at least one memory 22 and the computer program code 26 configured to, with the at least one processor, provide the controller 14.

The detector 12 and the controller 14 may be provided by the same software application or by different software applications 24, 26 concurrently running on the same processor or processors.

FIG. 3 schematically illustrates a gesture recognition engine 30 for a gesture controlled user interface. The engine 30 comprises: an input interface 36 for connection to multiple radio receivers 10 for receiving radio signals, the detector 12 and an output interface 38 for providing detected attributes (and possibly parameters) as an output. The detector 12 is configured to detect an attribute of received signals, for each of the multiple receivers 10, that varies with the position of the object. It operates in the same manner as the detector 12 described with reference to FIG. 1.

The detector 12 comprises an attribute detection block 32 for each radio receiver 10. There is an attribute detection block 32ⱼ (j=1, 2, . . . ) for the respective radio receiver 10ⱼ. The attribute detection block 32ⱼ is configured to detect an attribute of radio signals 6ⱼ′ received at the radio receiver 10ⱼ.

The detector 12 comprises a parameterization block 34 for each radio receiver 10. There is a parameterization block 34ⱼ for the respective radio receiver 10ⱼ. The parameterization block 34ⱼ is configured to determine one or more time variable parameters that parameterize the gesture. The parameters may be, for example, parameters described above such as power, frequency shift, speed, direction, range etc

The engine 30 may be integrated on a chip set, a module and/or as a discrete circuit.

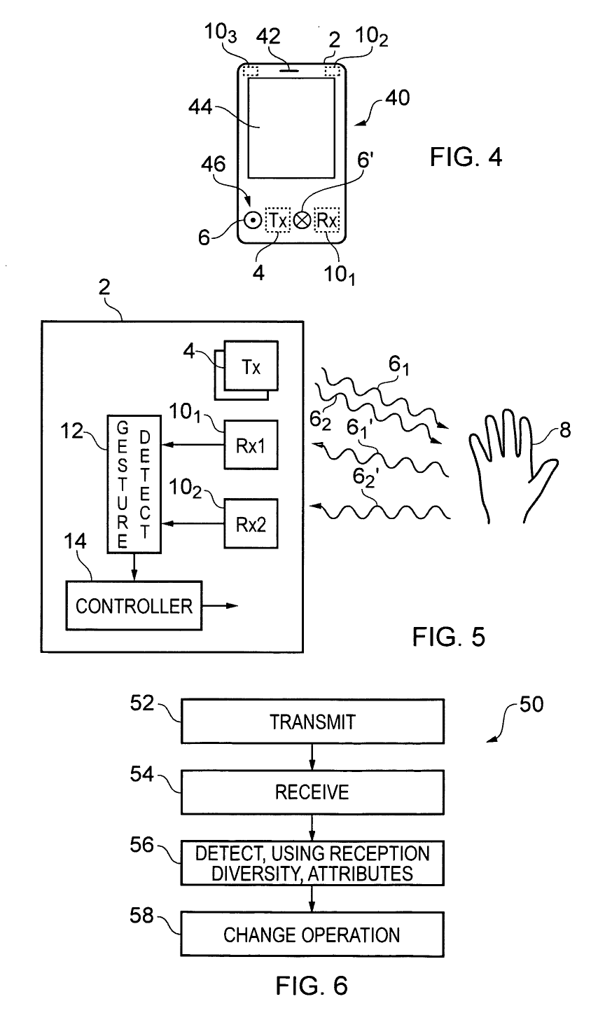

FIG. 4 schematically illustrates an exterior of an apparatus 2. The apparatus 2 in this embodiment is a portable apparatus that has a front face 46 comprising a user interface. The user interface comprises an audio output port 42 and a display 44. The apparatus 2 as illustrated in FIG. 1 comprises a radio transmitter 4 and a plurality of radio receivers 10₁, 10₂, 10₃ However, as these are generally housed within the exterior of the apparatus 2 and are not visible at the exterior they are illustrated using dotted lines. In this example, the radio transmitter 4 is configured to produce a directed transmission in which the radio signals predominantly travel outwardly away from and normally to the front face 46 of the apparatus 2. The reflected radio signals 6′ travel inwardly towards the front face 46.

In this and other embodiments, the controller 14 (not illustrated in FIG. 4) may be configured to maintain a correspondence between the time varying nature of the input command and the time varying nature of the attributes.

The controller 14 may be configured to provide a slowly varying and apparently analogue control when the detector 12 detects a slowly moving continuous gesture. For example, if a hand gesture involved moving a hand slowly towards the front face 46, the smooth and continuous control may involve slowly reducing the volume of an audio output. For example, if a hand gesture involved moving a hand slowly away from the front face 46, the apparently analogue control may involve slowly increasing the volume of an audio output. Similar control may alternatively be provided instead for zooming in and out or scrolling on a display 44 of the apparatus 2, for example.

The controller 14 may be configured to provide a binary two-state control when the detector 12 detects a fast moving gesture. For example, if a hand gesture involved moving a hand quickly towards the front face 46, the binary control may involve muting the volume of an audio output. For example, if a hand gesture involved moving a hand quickly away from the front face 46, the binary control may involve exiting a currently running application.

FIG. 5 schematically illustrates an alternative embodiment of the apparatus 2 that uses transmission diversity in addition to reception diversity. There are a plurality of radio transmitters 4 and a plurality of radio receivers 10. The first radio transmitter transmits first radio signals 6₁ that are reflected off the gesturing hand 8 and received, as reflected first radio signals 6₁′ at the first receiver 10₁. The second radio transmitter transmits second radio signals 6₂ that are reflected off the gesturing hand 8 and received, as reflected second radio signals 6₂′ at the second receiver 10₂. The third radio transmitter transmits third radio signals (not illustrated) that are reflected off the gesturing hand 8 and received, as reflected third radio signals (not illustrated) at the third receiver 10₁.

The detector 12 is configured to detect separately, for each of the plurality of receivers 10, an attribute of the received signals that varies with the position of the moving hand 8.

The controller 14 is configured to interpret the combination of attributes associated with the respective radio receivers as a predetermined user input command and change the operation of the apparatus 2.

The detector 12 may additionally parameterize each of the received radio signals 6′ into parameters such as power, frequency shift, speed, direction, range, etc.

The controller 14 may use a knowledge of the relative positions of the radio receivers 10 and attributes determined for each receiver to resolve the position of the hand in two or three dimensions. The change in the position of the hand can identify a gesture.

The controller 14 may use a knowledge of the relative positions of the radio receivers 10 and parameters determined for each receiver to help resolve the velocity or distance of the hand in two or three dimensions.

In this multiple-transmitter configuration, each radio transmitter 4 can point at the same angle or at different angles/directions.

FIG. 6 schematically illustrates a method 50 comprising: at block 52, transmitting radio signals 6 that are at least partially reflected by an object 8 moving as a consequence of a gesture; at block 54, receiving the transmitted radio signals 6′ after having been at least partially reflected by the object 8 moving as a consequence of a human gesture; at block 56, detecting an attribute for each of the multiple receivers that varies with the position of the object and that collectively characterize the gesture; and at block 58, changing the operation of an apparatus 2 in dependence upon the detected attributes characterizing the gesture.

The method may also comprise determining one or more parameters that parameterize a gesture as has been described previously with respect to operation of the apparatus 2.

As used here ‘module’ refers to a unit or apparatus that excludes certain parts/components that would be added by an end manufacturer or a user.

The blocks illustrated in the FIG. 6 may represent steps in a method and/or sections of code in the computer program. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

The controller 14 may be configured to determine when a gesture detected by the detector 12 is valid or even when the radar detection is turned on. An external event, such as an alarm, alert or other event may enable the controller 14. The enabled controller then enables the radio transmitter, radio receiver and detector and is itself enabled to interpret an attribute detected by the detector 12 as a predetermined user input command and change the operation of the apparatus 2. Different gestures may produce different user input commands. This enablement, for gesture detection, may last while the external event is occurring or for a predetermined duration after the event starts.

For example, when there is an incoming telephone call, in one embodiment the controller 14 turns the radar on and it is configured to interpret attribute detected by the detector 12 as a predetermined user input command and change the operation of the apparatus 2. Different gestures may produce different user input commands which may, for example, answer the call, cancel the call or divert the call to, for example, voicemail. This enablement, for gesture detection, may last while the external event is occurring or for a predetermined duration after the event starts.

As another example, when there is an alarm alert, in one embodiment the controller 14 turns the radar on and it is configured to interpret attribute detected by the detector 12 as a predetermined user input command and change the operation of the apparatus 2. Different gestures may produce different user input commands which may, for example, silence the alarm permanently or temporarily silence the alarm. This enablement, for gesture detection, may last while the external event is occurring or for a predetermined duration after the event starts.

As another example, in a camera application when a user activates a ‘remote control’ mode, the controller 14 turns the radar on and it is configured to interpret detected attributes, for the receivers, as a user input associated with a gesture and change the operation of the apparatus 2. A large scale gesture may produce a user input command which may, for example, take the picture after a very short delay or when the absence of movement or gestures has been detected. Alternatively, the absence of movement or gestures may produce a user input command which may, for example, take the picture after a very short delay. In a further embodiment, a large scale gesture may produce a user input command which may, for example, cause the camera to produce an audible sound to attract attention, followed by a visual indicator to draw the subjects' gaze, followed by taking the picture when the absence of movement or gestures has been detected.

In other embodiments, a non-touching gesture may be combined with one or more additional user input commands that ‘primes’ the apparatus to detect the gesture. The additional user input command may be, for example, an audio input command, a voice command, an input command from a mechanical button, or a touch-based input command such as actuating a button. The additional user input command may be carried out simultaneously with the gesture or the gesture may need to follow within a time window immediately following the additional user input command. The additional user input command is a simple way of filtering out unwanted gestures. In some but not necessarily all embodiments, the radar may be turned off by a predetermined gesture, either preprogrammed into the apparatus by the user or created by learning the gestures of the user. This may facilitate ending the radar input session so that energy is saved in the apparatus for other functions and to prevent other people or objects changing a function of the apparatus.

For example, in a map application pressing a certain button while moving a hand towards the device could be interpreted as zoom in, whereas pressing the same button and moving the hand away could be interpreted as zoom out. Pressing a different button while moving a hand towards the device could scroll the screen up, whereas pressing the same button and moving the hand away from the device would cause scrolling the screen down. Pressing a third button with the same gesture would scroll screen left etc. The buttons could be part of a touch screen or discrete buttons.

Referring to FIG. 1, there could be an embodiment where there is a connection between the radio transmitter 4 and the radio receiver 10, for example, a local oscillator may be present and connected between the transmitter and one or more receivers. In addition, there could be feedback from the controller 14 to the radio transmitter 4 and radio receiver 10 for adjusting their parameters such as transmit power, frequency, receiver sensitivity, etc.

Referring to FIG. 1, although a single radio transmitter 4 is described. it should be appreciated that there may, in other embodiments, be transmission diversity using multiple antennas for multiple radio transmitters 4 or multiple antennas for a single radio transmitter 4. These sources of radio signals could be placed pointing at different directions, e.g. one for the front face and one for the back cover so that we can select the relevant directional source of radio signals for different gesturing applications, or even use them at the same time.

Although in the preceding description, a human user gesture has been detected as a user input command, in other embodiments the gesture may be performed by a non-human such as animals, robots or machines and alternatively by an object worn or held by the user, for example, a piece of jewellery or a wristwatch. The object may be additionally security mapped to the apparatus so that only a security mapped object, which has been authenticated by the apparatus, may provide a gesture to the apparatus. This way the apparatus will be safe from erroneous inputs from other objects and/or human user gestures causing the apparatus to do something unwanted.

Although in the preceding description, a gesture has been performed as an ‘external gesture’ in which, for example, a human hand is actively moved relative to a stationary apparatus 2, it should be understood that a gesture may also be an ‘integrated gesture’ in which the apparatus 2 is actively moved relative to an environment that is detectable by radar. The apparatus 2 may be hand portable and the environment may be provided, at least in part, by a user's body.

Referring to FIG. 1, the radio transmitter 4 may, in some embodiments, be configured to transmit at multiple different center frequencies and multiple frequency bands. Different countries allow different frequencies to be used for radar purposes. The apparatus 2 may be configured to operate at multiple frequencies and, when incorporated with a mobile cellular telephone could determine and use suitable frequencies based on the country information the cellular telephone receives from a cellular network.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
one or more radio transmitters configured to transmit radio signals that are at least partially reflected by an object or objects moving as a consequence of a gesture;
multiple radio receivers configured to receive the transmitted radio signals after having been at least partially reflected by an object or objects moving as a consequence of a gesture;
a detector configured to detect an attribute of the received signals, for each receiver, that varies with the position of the object or objects moving as a consequence of the gesture; and
a controller configured to interpret the detected attributes, for the receivers, as a user input associated with the gesture.

2. An apparatus as claimed in claim 1, wherein the detector is configured to detect as an attribute, a phase of the received signals for each receiver and the controller is configured to use the phases, for the receivers, to determine an object location or bearing, which is interpreted as the user input.

3. An apparatus as claimed in claim 1, wherein the detector is configured to detect, for each receiver, a time value for the received signals indicative of the time between transmission and reception and wherein the controller is configured to use the time values, for the receivers, to determine an object position, which is interpreted as the user input.

4. An apparatus as claimed in claim 1, wherein the controller is configured to detect a predetermined time variation in attributes as an associated predetermined user input command and to change the operation of the apparatus in an associated predetermined manner.

5. An apparatus as claimed in claim 1, wherein the detector is configured to determine, with respect to a user gesture that reflects the transmitted radio signals to provide the received radio signals, one or more parameters that parameterize a gesture.

6. An apparatus as claimed in claim 5, wherein the parameters are or are based upon a Doppler frequency shift for each radio receiver.

7. An apparatus as claimed in claim 1, wherein the controller is configured to maintain a correspondence between a time varying nature of the input command and a time varying position of the object or objects.

8. An apparatus as claimed in claim 1, wherein the controller is configured to provide slowly varying and smooth and continuous control when the detector detects a slowly moving continuous gesture.

9. An apparatus as claimed in claim 1, wherein the controller is configured to provide binary two-state control when the detector detects a fast moving gesture.

10. An apparatus as claimed in claim 1, wherein the controller is configured to change how content is presented to a user.

11. An apparatus as claimed in claim 1, wherein the controller is configured to change any one or more of: audio output increase, audio volume decrease, display zoom-in, display zoom-out, display scroll-up, display scroll-down, display scroll-right, display scroll-left in response to an associated detected user gesture, a telephone call state, a camera capture state

12. An apparatus as claimed in claim 1, wherein the apparatus comprises at least one processor and at least one memory including computer program code, the at least one memory and the computer program code configured to, with the at least one processor provide the detector and wherein the apparatus comprises at least one processor and at least one memory including computer program code, the at least one memory and the computer program code configured to, with the at least one processor provide the controller.

13. An apparatus as claimed in claim 1, wherein the apparatus has a front face and wherein the radio transmitter is configured to transmit radio signals at least substantially normally to the front face and wherein the multiple radio receivers are configured to receive radio signals that are reflected towards the front face.

14. An apparatus as claimed in claim 1, wherein the apparatus is configured to additionally use the radio transmitter for wireless data transmission.

15. An apparatus as claimed in claim 1, wherein a separate user actuation in addition to a gesture is required to enable a change in the operation of the apparatus in response to a gesture.

16. An apparatus as claimed in claim 1, configured to operate with transmission diversity.

17. An apparatus as claimed in claim 1, wherein the controller is user programmable to predetermine time-varying attributes for gestures.

18. A gesture recognition engine for a gesture controlled user interface comprising:
a detector configured to detect an attribute of received signals for each of a plurality of receivers that varies with the position of the object or objects and configured to detect at least one additional parameter for each of the plurality of receivers; and
an interface for providing the detected attributes and parameters as an output.

19. A method comprising:
transmitting radio signals that are at least partially reflected by an object or objects moving as a consequence of a gesture;
receiving the transmitted radio signals at multiple receivers after having been at least partially reflected by the object or objects moving as a consequence of a gesture;
detecting an attribute of the received signals for each of the multiple receivers that varies with the position of the object or objects that characterize the gesture; and
changing the operation of an apparatus in dependence upon the detected attributes characterizing the gesture.

20. A method as claimed in claim 19 further comprising: determining one or more parameters that parameterize a gesture and using the determined parameters to assist in the characterization of a gesture.
